(19) United States
(12) Patent Application Publication
(10) Pub. No.: US 2006/0158434 A1
(43) Pub. Date: Jul. 20, 2006

(54) Electronic payment terminal with active cover

(76) Inventors: Anthony E. Zank, (US); Paul M. Zank, (US)

Correspondence Address: SHELDON & MAK, INC, 225 SOUTH LAKE AVENUE, 9TH FLOOR, PASADENA, CA, 91101, US

(21) Appl. No.: 11/040,050

(22) Filed: Jan. 20, 2005

(51) Int. Cl. G09G 5/00

(52) U.S. Cl. 345/168

(57) ABSTRACT

An apparatus useful in facilitating commercial transaction payments as a secured electronic payment terminal and a thin keyboard cover. The keyboard cover is adjustably attached to the electronic payment terminal so that the keyboard cover can alternatively serve to cover the keyboard or to swing away from the keyboard to provide a security panel. The keyboard cover is “active,” in that it incorporates a data communicator for transmitting or receiving data from an outside source. In one embodiment, the data communicator includes a signature pad. The keyboard cover is removable from the electronic payment terminal for maintenance and/or replacement without having to access the internals of the electronic payment terminal, including its electronic circuitry.

### FIELD OF THE INVENTION

This invention relates generally to secured electronic payment terminals and similar equipment.

### BACKGROUND OF THE INVENTION

Electronic payment terminals have become very common as tools in most banking and retail transactions. Many such electronic payment terminals require a keypad so that the payor can enter his or her “PIN” number.

Security for such electronic payment terminals is extremely important. Recently, several trade associations, including EMVCo, LLC, have proposed protocols for electronic payment terminals which incorporate stringent security procedures. One such security procedure requires that each electronic payment terminal go through a rigorous certification procedure to certify the security features built into the electronic payment terminal. Additionally, such security procedures typically require that all secure information within the electronic payment terminal be automatically erased upon any breaching of the electronic payment terminal housing or its internal electronic circuitry. The erasure of such proprietary internal information requires that the electronic payment terminal go through a time consuming and expensive recertification procedure.

In addition to the use of electronic payment terminals, banks and retail establishments are increasingly moving towards the use of electronic signature devices. An electronic signature device has an electronic screen or a sheet of paper disposed over an electronic screen. The customer is asked to sign his or her signature on the screen or on a sheet of paper which overlays the screen. The screen automatically picks up the customer's signature and relays it to a central location for authentification.

A problem with electronic signature devices is that the electronic screen is easily scratched and/or quickly wears out. For these reasons, the screen needs to be frequently replaced.

Banking and retail establishments often find it cumbersome to use both an electronic payment terminal and a separate electronic signature device, because the use of the two separate devices frequently takes up an undue amount of precious counter space. Accordingly, there have been several attempts to incorporate an electronic signature device with an electronic payment terminal. However, such attempts have been less than wholly successful. One problem with combining electronic signature and electronic payment terminals is that the electronic signature screen tends to be at an awkward angle with respect to the signator. This often leads to signatures which do not closely match the ink-on-paper signature of the signator, so that the electronic signature is rejected as false.

Another problem with combined electronic signature and electronic payment terminal units is that the face of such units is unduly large and, again, takes up an undue amount of counter space.

Finally, a problem with combined electronic signature and electronic payment terminal units is that, when the signature screen of the electronic signature device has to be replaced, the internals of the housing, which include the electronic payment terminal, must be breached. Under the new industry group protocols, such breaching of the electronic payment terminal housing will require the electronic payment terminal portion to go through an expensive and time-consuming recertification process.

Accordingly, there is a need for a combined electronic signature and electronic payment terminal unit which avoids these problems with the prior art.

Additionally, many forms of biometric data, such as hand geometry, fingerprints and iris scans, and many forms of informational data, such as passwords, PIN numbers and maiden names, can be used to verify the identity of an individual engaged in a transaction, either together with or instead of the individual's signature. The input of biometric data typically requires a flat surface having biometric sensors incorporated therein. The input of informational data also typically requires a flat surface. Accordingly, it would be desirable to provide a small, compact terminal having a flat surface into which can be entered biometric data and/or informational data.

Moreover, for terminals adapted to enter informational data, it is desirable to shield the keypad from observation by third parties, so that the individual's information is not compromised and is kept secret.

### SUMMARY

The invention is an apparatus comprising (a) a secured electronic payment terminal having a housing, a keyboard and electronic circuitry; and (b) a thin keyboard cover adjustably attached to the electronic payment terminal such that the keyboard cover can be adjusted between (i) a first keyboard cover position wherein the keyboard cover is disposed proximate to and generally parallel with the keyboard and wherein the keyboard cover at least partially covers the keyboard, and (ii) a plurality of stable second keyboard cover positions wherein the keyboard cover is disposed not generally parallel with the keyboard and wherein the keyboard cover does not cover the keyboard, the keyboard cover comprising a data communicator for transmitting or receiving data from an outside source other than the electronic payment terminal, the keyboard cover being removable from the electronic payment terminal without having to access the housing of the electronic payment terminal and without having to access the electronic circuitry of the electronic payment terminal.

In a preferred embodiment of the invention, the keyboard cover comprises one or more side wings adapted to shield the keypad from observation by third parties.

### DRAWINGS

These and other features, aspects and advantages of the present invention will become better understood with reference to the following description, appended claims and accompanying drawings where:

FIG. 1 is a perspective view of an apparatus having features of the invention;

FIG. 2 is a second perspective view of the apparatus in FIG. 1, showing the keyboard cover in a raised position;

FIG. 3 is a front view of the apparatus illustrated in FIG. 2;

FIG. 4 is a side view in partial cross section of the apparatus illustrated in FIG. 2, taken along line 4-4; and

FIG. 5A is a front view of an alternative embodiment having a telescoping portion, shown with a telescoping portion in a retracted position;

FIG. 5B is a front view of an alternative embodiment having a telescoping portion, shown with a telescoping portion in an extended position;

FIG. 6A is a front view of an alternative embodiment of the invention having side wings, the side wings being shown disposed in a retracted position;

FIG. 6B is a front view of the embodiment illustrated in FIG. 6A showing the side wings in an extended position;

FIG. 7A is a front view of an alternative embodiment of the invention having accordion portions, shown in a retracted position; and

FIG. 7B is a front view of the alternative embodiment illustrated in FIG. 7A, shown with the accordion portion in an extended position.

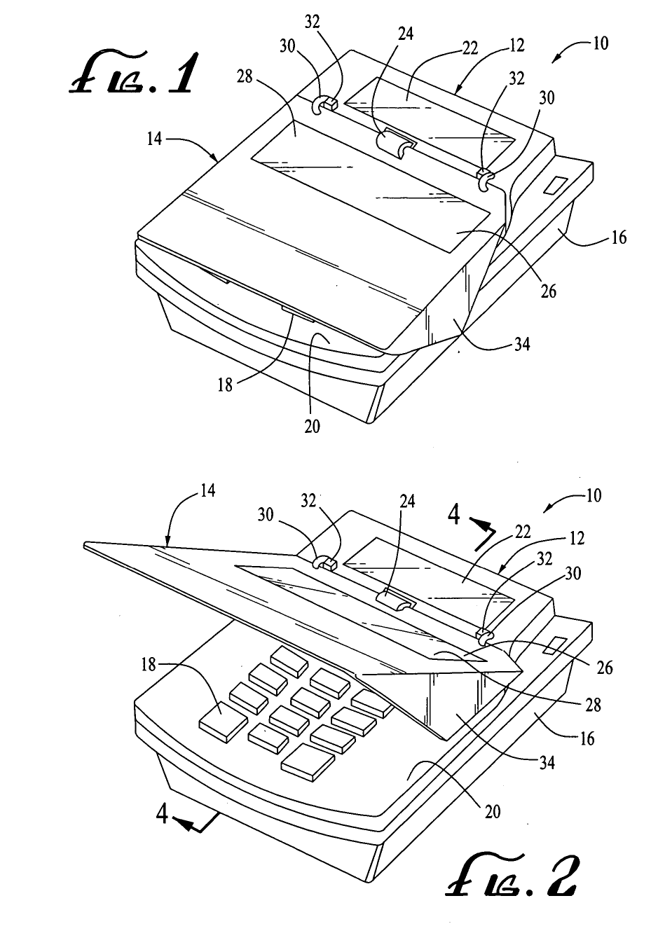

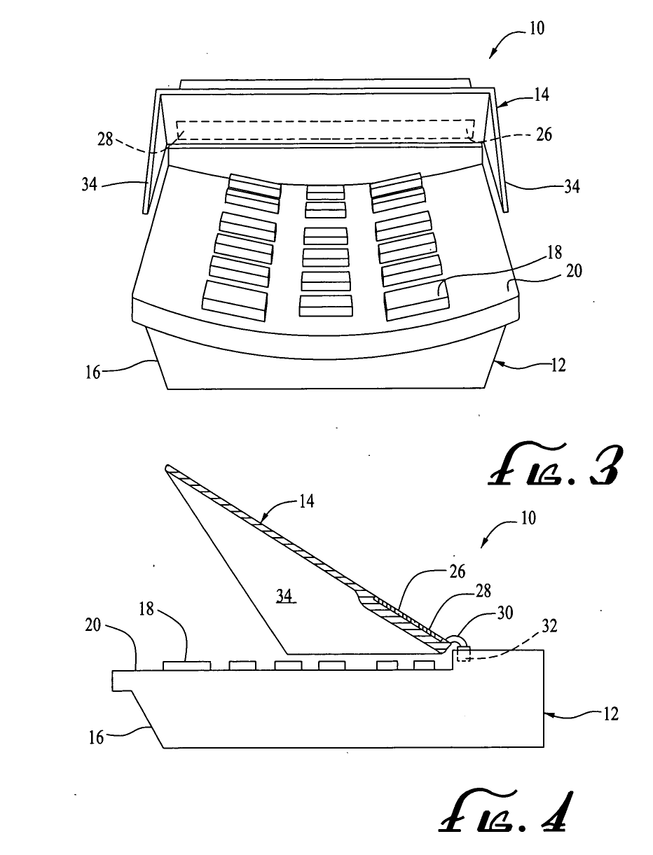

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is an apparatus 10 for facilitating commercial transaction payments. The apparatus comprises a secured electronic payment terminal 12 and a unique keyboard cover 14.

The secured electronic payment terminal 12 can be any one of the wide variety of secured electronic payment terminal designs. The secured electronic payment terminal 12 comprises a housing 16, an external keyboard 18 protruding above the housing 16 and internal electronic circuitry (not shown) for gathering information provided by the operation of the keyboard 18 and for exchanging information with external, remotely located computers.

A typical secured electronic payment terminal 12 is illustrated in the drawings. In this embodiment, the housing 16 has a generally rectangular upper surface 20. The upper surface 20 comprises the keyboard 18. In the embodiment illustrated in the drawings, the upper surface 20 further comprises a digital information screen 22 for conveying information and instructions to the user.

The secured electronic payment terminal 12 is generally about the size as a small electronic calculator, so as to minimize the amount of counter space necessary to retain the payment terminal 12.

The keyboard cover 14 is adjustably attached to the payment terminal 12 such that the keyboard cover 14 can be adjusted between (i) a first keyboard cover position wherein the keyboard cover 14 is disposed proximate to and generally parallel with the keyboard 12, and wherein the keyboard cover 14 at least partially covers the keyboard 12, and (ii) a plurality of stable second keyboard cover positions wherein the keyboard cover 14 is disposed not generally parallel with the keyboard 12 and wherein the keyboard cover 14 does not cover the keyboard 12.

Typically, the keyboard cover 14 is as thin as practical, typically between about 0.1 inches and about 0.5 inches.

In the embodiment illustrated in the drawings, the keyboard cover 14 is attached to the payment terminal 12 by a hinge 24 which allows the keyboard cover 14 to be raised or lowered. When the keyboard cover 14 is raised above the keyboard 12, it can be stably retained in any number of an infinite number of positions above the keyboard 12.

In the embodiment illustrated in the drawings, the keyboard cover 14 completely covers the keyboard 12 in the first keyboard position. Typically, the keyboard cover 14 abuts the keyboard cover 14 in the first keyboard cover position.

The keyboard cover 14 comprises a data communicator 26 for transmitting or receiving data from an outside source other than the electronic payment terminal 12. The data communicator 26 can comprise a signature tablet, touch pad, pointing device, LCD display, fingerprint scanner, audio speaker, microphone, wireless or wired interface, motion sensor or other appropriate data communications device. In the embodiment illustrated in the drawings, the data communicator 26 is a signature touch pad 28.

Where the data communicator 26 comprises an LCD display or similar data display screen, the data communicator 26 can be used to display instructions, information, content of the transaction requiring approval and/or advertising.

The data communicator 26 is electrically connected with the electronic circuitry within the housing 16 of the payment terminal via one or more cables 30.

The keyboard cover 14 is attached to the payment terminal 12 such that the keyboard cover 14 is removable from the payment terminal 12 without having to access the interior of the housing 16 of the payment terminal 12 and without having to access the electronic circuitry within the payment terminal 12. In the embodiment illustrated in the drawings, this is accomplished by disconnecting each of the cables 30 at an externally located cable disconnect 32 and then opening the externally located hinge 24.

In the embodiment illustrated in the drawings, the keyboard cover 14 further comprises a pair of opposed side wings 34. Such side wings 34 provide additional privacy to a user using the keyboard 18.

The side wings 34 can be adapted to be extendable by standard techniques including wing extension panels, auxiliary folded wing extension members, or telescoping extension members. Additionally, the side wings 34 can be made of cloth or other material so that the wings are not obtrusive when the keyboard cover 14 is in the down position, but which are effective in shielding all view of the keypad (or biometric sensor pad) to provide additional privacy protection to the apparatus 10.

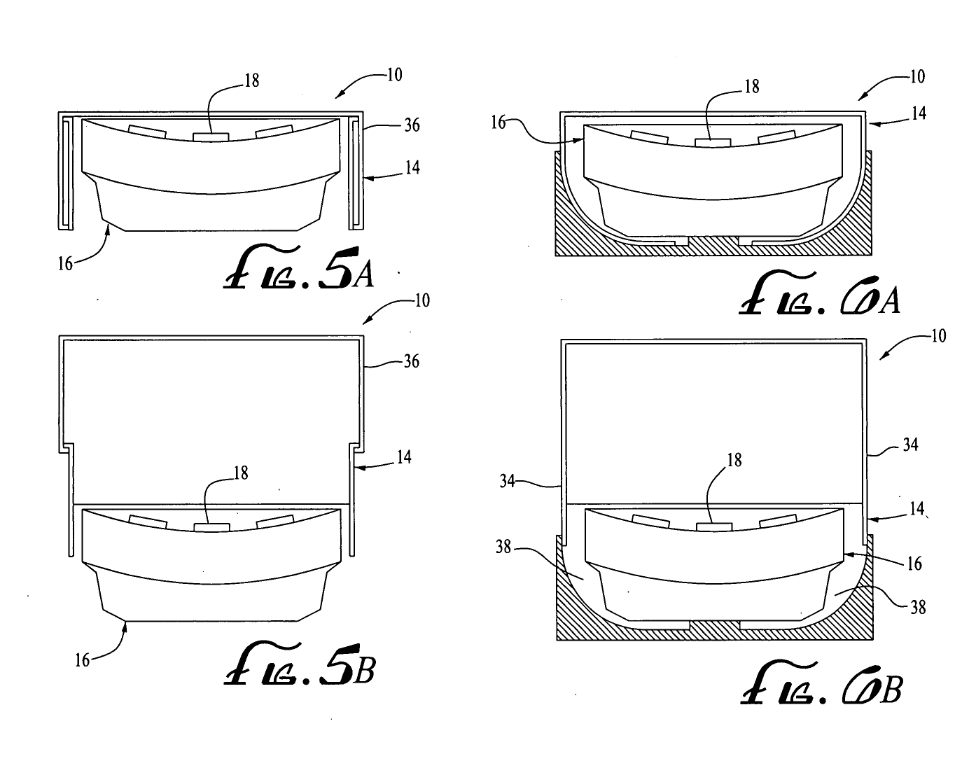

FIGS. 5A and 5B illustrate an embodiment of the invention wherein the keyboard cover 14 has a telescoping portion 36 which can be extended upwardly when the keyboard cover 14 is in the open position to provide the keyboard cover 14 with additional height, and to thereby provide the user with additional privacy.

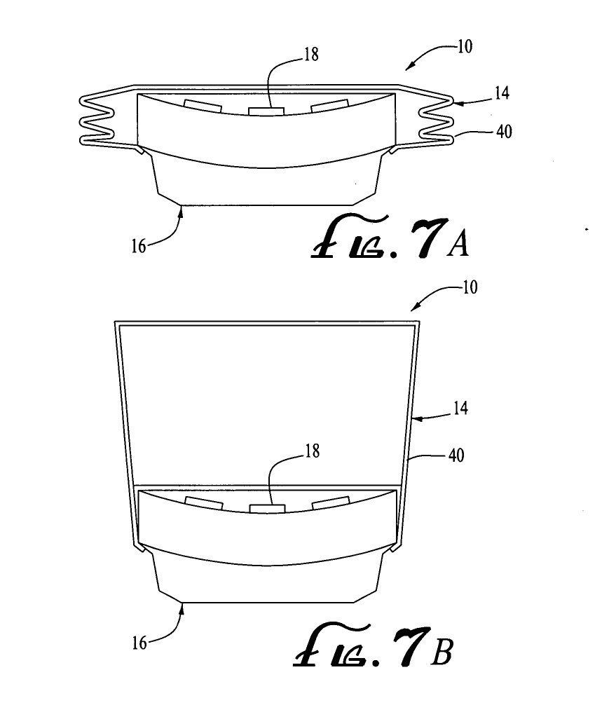

FIGS. 6A and 6B illustrate an embodiment of the invention wherein the keyboard cover 14 has side wings 34 of extended width. The side wings 34 are made from a flexible material so that they can be conveniently stored within pockets 38 surrounding the secured electronic payment terminal 12. However, when the keyboard cover 14 is placed in the open position, the side wings 34 are extendable to provide additional width, and to thereby provide the user with additional privacy.

FIGS. 7A and 7B illustrate an embodiment of the invention wherein the keyboard cover 14 comprises a pair of opposed accordion suctions 40. As illustrated, the accordion sections 40 can be folded when the keyboard cover 14 is in the down position. However, when the keyboard cover 14 is in the up position, the accordion sections 40 can be extended flat so as to provide the keyboard cover 14 with additional area, and to thereby provide the user with additional privacy.

In operation, a commercial establishment locates the apparatus 10 of the invention proximate to the point of sale or transaction, such as on a countertop next to a cash register or at a teller window, new account desk or sales desk. Because the data communicator 26 is disposed in the keyboard cover 14, and because the keyboard cover 14 is attached to the payment terminal 12, the device is a relatively small “footprint,” and takes up little area on the countertop. The user can be instructed in the use of the apparatus 10 via the digital information screen 22. When so instructed, the user can enter his or her PIN number in privacy by precisely positioning the keyboard cover 14 such that no one can see the buttons on the keyboard 18 which he or she pushes. Afterwards, the user may be instructed to sign his or her signature on the touch pad 28 which is built into the keyboard cover 14. Because the touch pad 28 in the keyboard cover 14 can be made to be approximately horizontal, the user does not have difficulty in making a true signature.

When the touch pad 28 in the keyboard cover 14 becomes scratched or otherwise damaged, the owner of the apparatus 10 can easily replace the touch pad 28 by disconnecting and replacing the keyboard cover 14. Because the keyboard cover 14 can be easily replaced without having to access the interior of the payment terminal housing 16, the security of the payment housing 16 is not breached and the owner does not have to incur loss of time and money to recertify the payment terminal 12.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. An apparatus useful in facilitating commercial transaction payments, the apparatus comprising:
(a) a secured electronic payment terminal having a housing, a keyboard and electronic circuitry; and
(b) a thin keyboard cover adjustably attached to the electronic payment terminal such that the keyboard cover can be adjusted between (i) a first keyboard cover position wherein the keyboard cover is disposed proximate to and generally parallel with the keyboard and wherein the keyboard cover at least partially covers the keyboard, and (ii) a plurality of stable second keyboard cover positions wherein the keyboard cover is disposed not generally parallel with the keyboard and wherein the keyboard cover does not cover the keyboard, the keyboard cover comprising a data communicator for transmitting or receiving data from an outside source other than the electronic payment terminal, the keyboard cover being removable from the electronic payment terminal without having to access the housing of the electronic payment terminal and without having to access the electronic circuitry of the electronic payment terminal.

2. The apparatus of claim 1 wherein the data communicator of the keyboard cover comprises a signature pad.

3. The apparatus of claim 1 wherein the data communicator of the keyboard cover comprises an LCD display.

4. The apparatus of claim 1 wherein the data communicator of the keyboard cover comprises a biometric input device.

5. The apparatus of claim 1 wherein the data communicator of the keyboard cover comprises a fingerprint scanner.

6. The apparatus of claim 1 wherein the data communicator of the keyboard cover comprises a hand geometry scanner.

7. The apparatus of claim 1 wherein the data communicator of the keyboard cover comprises a data display screen capable of displaying instructions, information, contents of the transaction requiring approval or advertising.

8. The apparatus of claim 1 wherein the thickness of the keyboard cover is between about 0.1 and about 0.5 inches.

9. The apparatus of claim 1 wherein the keyboard cover is hingedly attached to the electronic payment terminal.

10. The apparatus of claim 1 wherein the keyboard cover completely covers the keyboard in the first keyboard cover position.

11. The apparatus of claim 1 wherein the keyboard cover abuts the keyboard in the first keyboard cover position.

12. The apparatus of claim 1 wherein the keyboard cover is continuously adjustable, in that the plurality of stable second keyboard positions is an infinite number of stable second keyboard cover positions.

13. The apparatus of claim 1 wherein the keyboard cover comprises a pair of opposed side wings.

14. The apparatus of claim 13 wherein the side wings are made from a flexible material which can be stored within pockets surrounding the secured electronic payment terminal.

15. The apparatus of claim 1 wherein the keyboard cover comprises a telescoping portion which can be extended upwardly when the keyboard cover is in the open position.

16. The apparatus of claim 1 wherein the keyboard cover comprises a pair of opposed accordion sections which can be folded when the keyboard cover is in the down position and which can be extended flat when the keyboard cover is in the open position.
